(19) United States
(12) Patent Application Publication
(10) Pub. No.: US 2016/0325423 A1
(43) Pub. Date: Nov. 10, 2016

(54) UNIVERSAL TOOL MOUNT FOR MULTI-FUNCTION TOOL

(71) Applicant: Jameson Ellis, Sag Harbor, NY (US)

(72) Inventor: Jameson Ellis, Sag Harbor, NY (US)

(21) Appl. No.: 15/133,321

(22) Filed: Apr. 20, 2016

Related U.S. Application Data
(60) Provisional application No. 62/156,936, filed on May 5, 2015.
(60) Provisional application No. 62/324,940, filed on Apr. 20, 2016.

(51) Int. Cl. B25F 1/04; A44B 11/00; B25F 1/00

(52) U.S. Cl. CPC B25F 1/04; B25F 1/003; A44B 11/005

(57) ABSTRACT

Foldable pliers with plier head and handles, hinges disposed between the handles and the plier head, the handles defining on the insides thereof a cavity having a top inside wall. The foldable pliers operate such that when in a folded configuration, the foldable pliers define a gap between the plier head and the top inside wall and the foldable pliers are adapted to receive into the gap a mounting plate.

### CROSS REFERENCE TO RELATED APPLICATIONS

This application claims the benefit of U.S. Provisional Application No. 62/156,936, filed May 5, 2015, and incorporated herein by reference. This application further claims the benefit of U.S. Provisional Application No. 62/324,940, filed Apr. 20, 2016, and incorporated herein by reference.

### FIELD OF THE INVENTION

The present invention relates to universal mounts for various tools, in particular for multi-function tools. The universal mount permits detachable engagement of a multi-function tool to the universal mount.

### DESCRIPTION OF THE RELATED ART

Multi-function tools (also called “multi-tools”) are well known. In typical multi-function tools, pliers and other selected tools, such as screwdrivers, knife blades, files, etc., are provided in a single tool. Known multi-function tools often include pliers and have channel-shaped handles pivotally connected to the pliers' jaw members. Typically, the handles fold over so that the pliers are received in the channel-shaped handles. Also, the other tools fold over and are received in the channel-shaped handles as well.

The common element among such pliers-like tools is that each includes a pair of opposing jaws operated by a pair of opposing handles. It is understood that when the handles of such a jaw/handle combination store one or more tools, the entire device is then referred to as multi-function tool.

Such tools are typically stored in a pocket formed in one or both of the handle members. Examples of tools found in multi-tool handles include knife blades, can openers, screwdrivers, files, scissors, saw blades and the like. These tools fold into and out of the handle of the multi-tool, similar to a knife blade folding into and out of a pocket knife. Multi-tools often include other tools that do not fold, such as a ruler stamped into an exposed surface of one or both handles of the multi-function tool.

In order to store such multi-tools, various sheaths, pouches, holsters and other types of carriers are well-known for keeping multipurpose tools on a user's belt where they are disposed therein and are readily available for use. Some such useful articles are considered as a status symbols when carried in a visible location and can be a factor in determining which such multi-function tool is purchased instead of another.

However, such sheaths and other carriers are intended to carry a multi-function tool in a familiar location on a user, where the multi-function tool is easily and quickly available for use, and where the multi-function tool can be replaced easily enough that one is not tempted to set it down and thus risk leaving it behind and losing it.

While many previously available carriers and sheaths have included clips or arms that can be slipped over the top of a person's belt or be removed from the belt while it is being worn. Such clips, however, have not been able to fasten a carrier to a belt as securely as is desired, particularly when a carrier is to be used to carry an expensive multi-function tool or one which might be damaged if it falls.

Various sheaths for articles such as pagers or wireless telephones are not capable of securely and dependably holding heavier articles securely without the use of latches or flaps that must be unfastened and re-fastened in order to use and replace the article being carried and such an additional step required for use of such carriers may be enough to tempt a person using such a carrier to lay down an expensive multi-function tool or other article, rather than immediately replacing it into the carrier, with the result that the multi-function tool or other article is eventually left behind and lost.

Many sheaths, although secure, strong, easily used and good looking, such as some pouches or sheaths made of leather, are undesirably costly to produce and do not long maintain their good appearance in everyday use.

Relevant multi-function tools include, by way of non-limiting example, those disclosed in U.S. Pat. No. 8,376,199, and provisional application 62/129,166, incorporated herein by reference.

### SUMMARY OF THE INVENTION

Embodiments of the present invention provide a universal mount for a multi-function tool assembly.

Certain embodiments of the present a mountable tool invention include foldable pliers with plier head and handles, hinges disposed between the handles and the plier head, the handles defining on at least a portion of the insides thereof a cavity having a top inside wall. The cavity may have a height greater than the height of the plier head. These embodiments further have a mounting plate and operate such that when in a folded configuration, the foldable pliers define a gap between the plier head and the top inside wall and the foldable pliers are adapted to receive into the gap the mounting plate. It will be understood that this gap may be a “vertical”gap, that is, the gap being defined as a space disposed vertically above the top of plier head and the bottom of the top inside wall regardless of relative horizontal positioning.

Embodiments of the foregoing may also have a leaf spring in the mounting plate, a tab on the leaf spring and a receiver for the tab in the foldable pliers. In operation, when the mounting plate is received into the gap of the foldable pliers, the tab may engage with the receiver. There may also be a button on the leaf spring, wherein upon pushing the button the tab is disengaged from the receiver. It will be understood that the receiver may be formed anywhere on the pliers provided that it properly mates with the tab as appropriate.

Embodiments may further include hinges disposed between the plier head and the handles, wherein when the mounting plate is received into the gap of the foldable pliers, movement of the plier head relative to the handles is constrained by the hinge, the mounting plate and the handles.

As an alternative to all of the foregoing embodiments, the mounting plate may have a dovetail about a periphery, and the foldable pliers may be are adapted to receive into the gap the dovetail.

It will be understood that the tool of the present invention is not limited to pliers and that any tool may be constructed in accordance with the present invention such that the tool includes a folding handle forming the necessary gap between the handle cavity top inside wall and the operative “head” portion of the tool for receiving the mounting plate as described herein. Likewise, as described above, the tool of the present invention may be a multi-tool having additional tool elements stored, for instance, in one or both of the handle portions.

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

A preferred embodiment of the present is shown in the accompanying drawings.

### BRIEF DESCRIPTION OF THE DRAWINGS

The objects and features of the invention may be understood with reference to the following detailed description of an illustrative embodiment of the present invention taken together in conjunction with the accompanying drawings in which:

FIG. 1 is a bottom perspective view of a receiver of a preferred embodiment of the present invention.

FIGS. 2 and 3 are bottom perspective views of a receiver and tool of a preferred embodiment of the present invention, shown in varying degrees of engagement.

FIGS. 4 and 5 are bottom perspective views of a tool of a preferred embodiment of the present invention, shown in varying degrees of articulation.

FIG. 6 is a top perspective view of a receiver of a preferred embodiment of the present invention.

FIGS. 7 and 8 are top perspective views of a receiver and tool of a preferred embodiment of the present invention, shown in varying degrees of engagement.

FIGS. 9 and 10 are top perspective views of a tool of a preferred embodiment of the present invention, shown in varying degrees of articulation.

### DESCRIPTION OF THE PREFERRED EMBODIMENT

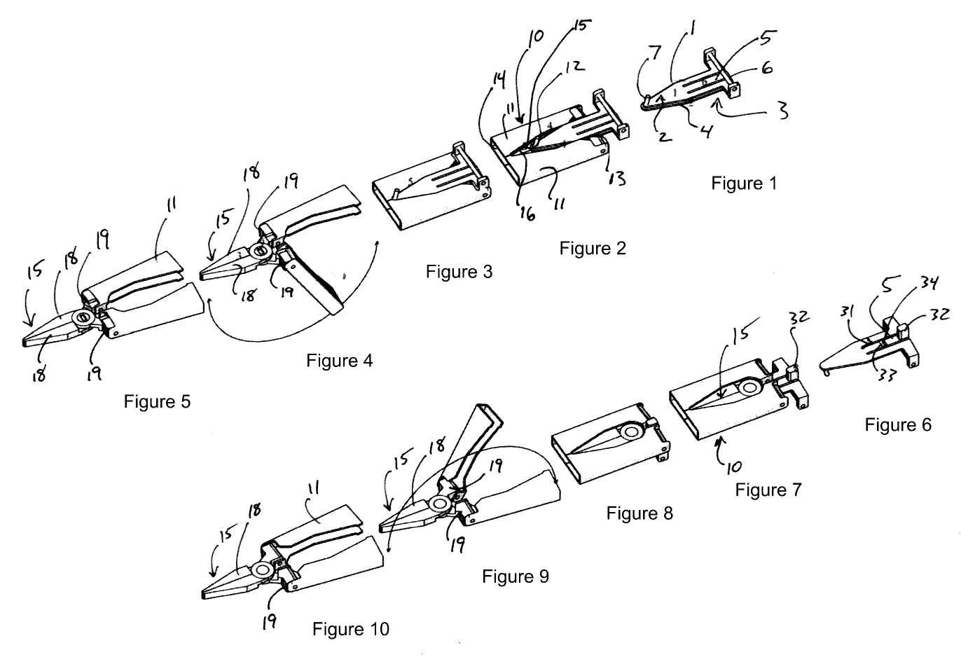

Referring to the preferred embodiment depicted in FIG. 1, a tapered plate 1 has tapered section 2 extending to a proximal end and straight section 3 extending to a distal end. The plate has dovetails 4 on opposing edges. A biasing member in the form of a leaf spring 5 is formed in at least a portion of the straight section 2 extending to the distal end. A belt receiver 6 is formed at or near the distal end for receiving an end of a garment belt (not shown). A pin member 7 is formed at or near the proximal end for coupling with a corresponding receiving structure in a garment belt (not shown).

FIGS. 2 and 7 depict the structure of FIG. 1 partially inserted into foldable pliers 10. When folded as shown in FIG. 2, plier handles 11 are folded co-extensively with plier head 15. Plier handles 11 are non-solid; that is, on the insides of at least a portion of each of the plier handles are formed a cavity 14. The plier handles are proportioned such that the height of cavity 14 is greater than the corresponding height of plier head 15, and handles 11 are shaped to follow the outline of plier head 15. Alternatively, handles 11 may be shaped differently than pliers head 15, in which case pliers head 15 may be accepted into cavity 14 when handles 11 are in folded position or otherwise accommodated between handles 11 when in folded position. In such embodiments, as a result of the difference in height between pliers head 15 and cavity 14, in the folded orientation depicted in FIG. 2 a gap 12 is formed between the top of pliers head 15 and the inside of the top of handles 11 in cavity 14 (i.e., in folded orientation, a small space remains above head 15 and below the top of the inside of handle 11).

In the folded orientation depicted in FIG. 2, handles 11 form an interstitial space 16 between them. Opening 13 may receive tapered plate 1 into interstitial space 16. Plate 1 is dimensioned so that the dovetails of plate 1 are received into gap 12. Furthermore, the shape of plate 1 may be dimensioned to conform to the shape of interstitial space 16.

As depicted in FIGS. 3 and 8, when fully inserted into foldable pliers 10, plate 1 forms a substantially unitary structure with foldable pliers 10. In this position, leaf spring 5 biases tab 31 (not shown here, shown in FIG. 6) downward to mate with a notch structure (not shown) formed in the foldable pliers 10, thereby retaining plate 1 in foldable pliers 10 and likewise retaining foldable pliers 10 on plate 1.

As shown inf FIGS. 4, 5, 9 and 10, pliers head 15, formed by pliers jaws jaws 18, rotate about hinges 19 and are constrained so that rotation of pliers head 15 relative to handles 11 is in one direction. In this manner, handles 11 cannot move relative to pliers head 15 when plate 1 is inserted into interstitial space 16, such movement constrained by the one-way rotation of hinge 19 in conjunction with the retentive force of dovetails 4 against handles 11.

Although not shown, plate 1 can have attached or formed into it a belt buckle mechanism, a spring steel clip or any other similar device or can be mounted on any surface to secure the tool.

FIG. 6 depicts plate 1 similarly to the depiction of FIG. 1 except from the top side. Tab 31 is shown on leaf spring 5. Tab 31 is shaped with an angled face 33 facing the proximal end of plate 1 and a substantially vertical face 34 facing the distal end of plate 1. The angled face and substantially vertical face operate to allow plate 1 to be pushed into opening 13 and latched to foldable pliers 10 while preventing movement in the opposite direction, as will be readily understood. Button 32 is provided to permit the manual biasing of the leaf spring 5 away from foldable pliers 10 to release plate 1 from foldable pliers 10.

Although the particular embodiments shown and described above will prove to be useful in many applications in the art to which the present invention pertains, further modifications of the present invention will occur to persons skilled in the art. All such modifications are deemed to be within the scope and spirit of the present invention as defined by the appended claims, as defined by the appended claims.

What is claimed is:

1. A mountable tool comprising:
foldable pliers comprising a plier head and handles, hinges disposed between said handles and said plier head, said handles defining on the insides thereof a cavity having a top inside wall, said cavity having a height greater than the height of said plier head;
a mounting plate;
wherein in a folded configuration, said foldable pliers define a gap between said plier head and said top inside wall;
and wherein said foldable pliers are adapted to receive into said gap said mounting plate.

2. The mountable tool of claim 1, further comprising:
a leaf spring in said mounting plate;
a tab on said leaf spring;
a receiver for said tab in said foldable pliers;
wherein when said mounting plate is received into said gap of said foldable pliers, said tab engages with said receiver.

3. The mountable tool of claim 2, further comprising a button on said leaf spring, wherein upon pushing said button said tab is disengaged from said receiver.

4. The mountable tool of claim 1, further comprising hinges disposed between said plier head and said handles, wherein when said mounting plate is received into said gap of said foldable pliers, movement of said plier head relative to said handles is constrained by said hinge, said mounting plate and said handles.

5. The mountable tool of claim 4, further comprising:
a leaf spring in said mounting plate;
a tab on said leaf spring;
a receiver for said tab in said foldable pliers;
wherein when said mounting plate is received into said gap of said foldable pliers, said tab engages with said receiver.

6. The mountable tool of claim 5, further comprising a button on said leaf spring, wherein upon pushing said button said tab is disengaged from said receiver.

7. A mountable tool comprising:
foldable pliers comprising a plier head and handles, hinges disposed between said handles and said plier head, said handles defining on the insides thereof a cavity having a top inside wall, said cavity having a height greater than the height of said plier head;
a mounting plate, said mounting plate having a dovetail about a periphery;
wherein in a folded configuration, said foldable pliers define a gap between said plier head and said top inside wall;
and wherein said foldable pliers are adapted to receive into said gap said dovetail of said mounting plate.

8. The mountable tool of claim 7, further comprising:
a leaf spring in said mounting plate;
a tab on said leaf spring;
a receiver for said tab in said foldable pliers;
wherein when said mounting plate is received into said gap of said foldable pliers, said tab engages with said receiver.

9. The mountable tool of claim 8, further comprising a button on said leaf spring, wherein upon pushing said button said tab is disengaged from said receiver.

10. The mountable tool of claim 7, further comprising hinges disposed between said plier head and said handles, wherein when said dovetail of said mounting plate is received into said gap of said foldable pliers, movement of said plier head relative to said handles is constrained by said hinge, said mounting plate and said handles.

11. The mountable tool of claim 10, further comprising:
a leaf spring in said mounting plate;
a tab on said leaf spring;
a receiver for said tab in said foldable pliers;
wherein when said dovetail of said mounting plate is received into said gap of said foldable pliers, said tab engages with said receiver.

12. The mountable tool of claim 11, further comprising a button on said leaf spring, wherein upon pushing said button said tab is disengaged from said receiver.

13. A mountable tool comprising:

[symbol]

14. [symbol] foldable pliers comprising a plier head and handles, hinges disposed between said handles and said plier head, said handles defining on the insides thereof a cavity having a top inside wall;
a mounting plate;
wherein in a folded configuration, said foldable pliers define a vertical gap between said plier head and said top inside wall;
and wherein said foldable pliers are adapted to receive into said vertical gap said mounting plate.

15. The mountable tool of claim 14, further comprising:
a leaf spring in said mounting plate;
a tab on said leaf spring;
a receiver for said tab in said foldable pliers;
wherein when said mounting plate is received into said vertical gap of said foldable pliers, said tab engages with said receiver.

16. The mountable tool of claim 15, further comprising a button on said leaf spring, wherein upon pushing said button said tab is disengaged from said receiver.

17. The mountable tool of claim 14, further comprising hinges disposed between said plier head and said handles, wherein when said mounting plate is received into said vertical gap of said foldable pliers, movement of said plier head relative to said handles is constrained by said hinge, said mounting plate and said handles.

18. The mountable tool of claim 17, further comprising:
a leaf spring in said mounting plate;
a tab on said leaf spring;
a receiver for said tab in said foldable pliers;
wherein when said mounting plate is received into said vertical gap of said foldable pliers, said tab engages with said receiver.

19. The mountable tool of claim 18, further comprising a button on said leaf spring, wherein upon pushing said button said tab is disengaged from said receiver.
